(19) United States
(12) Patent Application Publication
(10) Pub. No.: US 2007/0005401 A1
(43) Pub. Date: Jan. 4, 2007

(54) Method and system for processing reinsurance transactions

(75) Inventor: Elizabeth Vinyard, Montclair, NJ (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: American International Group, Inc., New York, NY (US)

(21) Appl. No.: 11/210,141

(22) Filed: Aug. 23, 2005

Related U.S. Application Data
(60) Provisional application No. 60/695,908, filed on Jun. 30, 2005.

(51) Int. Cl. G06Q 40/00

(52) U.S. Cl. 705/4

(57) ABSTRACT

A method and system provide computer-assisted reinsurance transaction processing to enable a user to handle the complicated aspects of applying treaty rules, processing negotiated requests, and obtaining required approvals. The computer-assisted transaction processing integrates applicable obligatory treaties and facultative obligatory treaties in the risk evaluation process, and allows the user to select and apply treaties to the reinsurance calculations. The computer-assisted transaction processing also provides functionality to facilitate facultative reinsurance by allowing the user to view, add, and modify negotiated quotes, and generating memoranda for confirming facultative reinsurance quotes. The computer-assisted reinsurance processing further assists the user in obtaining needed approvals by identifying approval requirements and generating and sending approval requests, and enhances the accuracy and validity of the data generated for the reinsurance transaction by performing automated validation on a worksheet used for the transaction processing. The computer-assisted reinsurance processing also facilitates the generation of various reports.

### FIELD OF THE INVENTION

The invention relates generally to reinsurance, and in particular to a computer-assisted method and system for processing reinsurance transactions.

### BACKGROUND OF THE INVENTION

Reinsurance is the assumption by one insurance company, the reinsurer, of all or part of a risk undertaken by another insurance company, the reinsured. The reinsured company is also referred to as the “ceding company,” because it is ceding or laying off a risk to the reinsurer. Processing a reinsurance transaction can be a very complicated task. For instance, each reinsurance application may involve different subparts, with each subpart having its own ceding limit, commission, attachment point, and cession premium. Moreover, each reinsurance transaction may be governed by one or more “treaties,” which are a form of reinsurance contracts wherein the terms and conditions generally apply to a book of business meeting specific predetermined criteria. A treaty may be “obligatory,” meaning that the subject matter business must be ceded by the ceding company in accordance with the terms in the treaty and must be accepted by the reinsurer. Alternatively, a treaty may be “facultative obligatory,” meaning that the terms and availability are predetermined for an entire class of risks, but the ceding of an individual eligible account is not necessarily automatic, depending on the definitions of what can be ceded. For a large insurance company with many branches and regional profit centers dealing with many different lines of business, there can be a large number of treaties, and identifying those treaties that may be applicable to a particular reinsurance transaction and applying them properly to the calculations can be very time consuming and difficult. Furthermore, for a given risk, there may be existing quotes that have already been negotiated, or quotes that are yet to be negotiated and agreed upon. In addition, approvals may be required for various reasons concerning, for example, treaty terms, security, or negotiation authority or limits for underwriting risks, etc. Due to all the numbers and rules negotiated quotes that have to be taken into account and approvals to be obtained, processing a reinsurance transaction can be a highly complex matter and is extremely prone to errors.

### SUMMARY OF THE INVENTION

In view of the foregoing, it is an object of the invention to provide a new way to process reinsurance transactions that can simplify and streamline the processing of reinsurance transactions to assist a reinsurance underwriter to navigate through the rather complicated reinsurance transaction processing and to improve the quality and accuracy of the results of the processing.

It is a related object of the invention to provide a way of processing reinsurance transactions that enables a reinsurance underwriter to easily and effectively apply relevant treaty rules, apply bound facultative reinsurance, and obtain necessary approvals for the reinsurance transactions.

It is another related object of the invention to provide a way of processing reinsurance transactions that is capable of minimizing errors in the reinsurance transaction processing.

It is yet another related object of the invention to improve the documentation of the reinsurance processing and to facilitate the viewing of data involved in the processing.

The present invention provides a method and system for computer-assisted reinsurance processing that can be integrated with the underwriting system of a reinsurance company to assist a user to go through the complicated operations involved in processing a reinsurance transaction and to handle the complicated aspects of applying treaty reinsurance, processing bound facultative reinsurance, and obtaining required approvals. The method and system in accordance with the invention automate a substantial portion of the processing of reinsurance by collecting and presenting applicable reinsurance data information, such as ceded premium, ceded limits, and approval requirements. As a result, the invention tremendously simplifies the otherwise highly complicated task of reinsurance transaction processing.

In accordance with a feature of the present invention, the computer-assisted transaction processing integrates applicable obligatory treaties and facultative obligatory treaties in the risk evaluation process, and allows the user to select and apply treaties to the reinsurance calculations. The computer-assisted reinsurance processing of the invention also provides functionality to facilitate facultative reinsurance, by allowing the user to view, add, and modify negotiated quotes, and generate memoranda regarding the facultative reinsurance quotes. In this regard, the computer-assisted processing of the invention may be integrated with an electronic platform for negotiating facultative reinsurance to ensure accurate data transfer and properly binding of quotes. Thus, the method and system of the invention provides a great degree of system automation to calculate automatically reinsurance premium distribution and liability allocation based on treaty rules and negotiated facultative reinsurance items.

Moreover, the computer-assisted reinsurance processing of the invention assists the user in obtaining needed approvals by identifying approval requirements and generating and sending approval requests for the user. In addition, the reinsurance processing in accordance with the invention enhances the accuracy and validity of the data generated for the reinsurance transaction by performing automated validation on a worksheet used for the transaction processing, and requiring the user to correct errors before allowing the worksheet to be finalized. Data generated for the transaction processing can be accessed for reporting needs, and the computer-assisted reinsurance processing provides report generation functionality to allow a user to generate various types of reports easily.

Further objects and advantages of the method and system for processing reinsurance transactions can be seen in the following detailed description of an embodiment of the invention with reference to the drawing, in which:

### BRIEF DESCRIPTION OF THE DRAWINGS

FIG. 1 shows a schematic view of a computer network implementing an embodiment of the invention for processing reinsurance transactions may be implemented;

FIG. 2 shows an exemplary user interface screen presented by a reinsurance module of a preferred embodiment for a user to view a list of pending risks;

FIG. 3 shows an exemplary user interface screen presenting a worksheet for a risk in a “Layoff Allocation” view;

FIG. 4 shows an exemplary “Structure Summary” user interface screen for presenting a summary of a structure or structures used in a reinsurance worksheet for a risk;

FIG. 5 is a schematic diagram showing a two-level filtering process for selecting treaties that may be applicable to a risk being evaluated for reinsurance;

FIG. 6 shows an exemplary user interface screen for displaying a list of treaties that may be applicable to a risk being evaluated;

FIG. 7 shows an exemplary user interface screen for showing details of a treaty that may be applicable to a risk being evaluated;

FIG. 8 is a schematic diagram showing the integration of the reinsurance module with an electronic platform for negotiating facultative reinsurance;

FIG. 9 shows an exemplary “Quote List” screen for displaying negotiated facultative reinsurance items;

FIG. 10 shows an exemplary “Facultative Detail by Quote” screen for showing details of a negotiated facultative reinsurance item;

FIG. 11 shows an example of a Memorandum of Facultative Reinsurance generated by the reinsurance module;

FIG. 12 shows an exemplary “View/Edit Certificate Number” screen;

FIG. 13 shows an exemplary interface screen for generating treaty/facultative obligatory approval request;

FIG. 14 is a schematic diagram showing the communications between an user of the reinsurance module and an approver for obtaining an approval;

FIG. 15 shows an exemplary “Errors/Warnings” screen for displaying error and warning messages;

FIG. 16 shows an exemplary “Transactions Details” screen for viewing details of a reinsurance transaction;

FIG. 17 shows an exemplary “REM Reports” user interface screen for the user to select reports to be generated; and

FIG. 18 shows an exemplary user interface screen for the user to select filters to be applied for generating a report.

### DETAILED DESCRIPTION OF EMBODIMENTS OF THE INVENTION

The present invention is directed to a method and system for reinsurance processing that can make the processing of reinsurance transactions tremendously easier for an underwriter and significantly improve the accuracy and reliability of the transaction processing. In a preferred embodiment described below, the method and system are implemented in a computer programming module that is hereinafter referred to as the “reinsurance module” or “REM.”

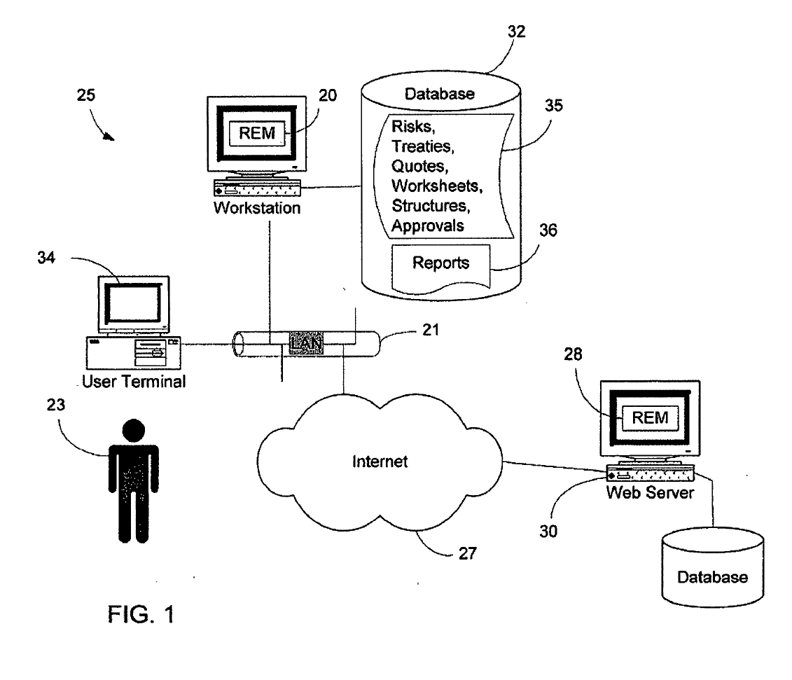

Referring now FIG. 1, the REM 20 may be accessible to users that need to use it for reinsurance processing in different ways. For instance, the REM 20 may be provided as a common utility on a local area network (LAN) 21 of a branch office or regional center of a reinsurance company. A user 23, who may be an underwriter, can log onto the local area network 21 and then launch the REM program 20 and run it to process a selected “risk” that is yet to be completed. As used herein, the term “risk” is generally synonymous with “insurance policy.” Alternatively, the REM may be a service 28 hosted by a web server 30 that may be accessed through an underwriting system, an intranet, or the Internet 27 by a user using his/her web browser. In that case, the user may be required to enter a valid user name and password before being allowed to use the REM 28. As illustrated in FIG. 1, the underwriting computer system 25 hosting the REM 20 includes a database 32 that contains data 35 for use by the REM to perform its functionality. As explained in greater detail below, the data 35 in the database 32 include data relating to pending risks, treaties, quotes, worksheets, structures, and approvals that are involved in different steps of the reinsurance transaction processing. In connection with the reinsurance transaction processing, the REM 20 also can be used to generate various reports 36 regarding reinsurance transactions that are completed or still in progress.

The REM 20 is designed to integrate with the underwriting system 25 of the users to improve the process of analyzing and booking reinsurance. Using the REM 20, the user 23 can calculate the reinsurance layoff allocation for a given risk. The layoff can then be passed back to the reinsurance management system at the regional center or the website for booking. When the layoff is finalized, the reinsurance structure used in generating the layoff will be retained in the reinsurance module, and the reinsurance premium will be kept for reference purposes.

As described below, the computer-assisted processing provided by the REM 20 offers significant advantages to the users, because it systemically applies treaty insurance, provides automation of treaty cession premium, facilitates the placement, pricing, negotiation and booking of facultative reinsurance, and provide a systemic means of analyzing the gross, ceded, and net premium and liability amounts in the “quote” phrase.

The REM 20 has many benefits. It can be used to maximize the underwriting profitability, and improve the accuracy of coding of the reinsurance information by reducing incorrect premium cessions, missed recoverables, delays in recoverable collections, and the time spent on investigating problems and recoding. It also streamlines underwriting activities that apply to reinsurance layoff and eliminates or reduces redundant work efforts. It further improves management reports since data can be centrally captured. Moreover, it allows an approval process to be embedded as part of the processing when reinsurance rules have been deviated from or when some special condition is requested. Ultimately, it provides a significantly greater degree of system automation to calculate automatically reinsurance premium distribution and liability allocation according to treaty abstract rules and premium allocation rules.

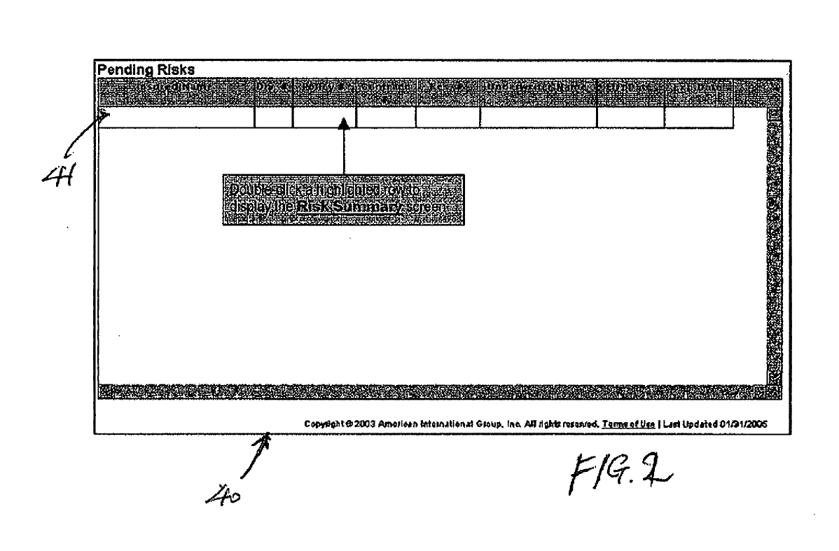

Turning now to FIG. 2, once the user gains access to the REM 20, the REM allows the user to see a Pending Risks screen 40 with a Pending Risks List table 41, which contains a list of pending risks captured in the database 32 of the underwriting system. Pending risks are risks that have been opened in the REM, but their necessary reinsurance data have not been finalized. The user can then select one risk from the Pending Risks List to view. The REM preferably also provides search capabilities for policies/accounts, pending risks, and pending tasks, and the searches may be performed by policy numbers, contract numbers, and names of the insured parties.

In accordance with a feature of the embodiment, to facilitate the processing of a selected pending risk, the REM 20 presents a worksheet for that risk that can be viewed on a user interface device such as a computer screen 34 of a user terminal. The worksheet is the tool utilized by a user to evaluate and layoff a risk to be reinsured. The worksheet captures pertinent policy data, reinsurance data, and cession information for a risk, and provides the user the ability to evaluate data for the risk. For instance, using the worksheet, the user can evaluate the net premium to determine whether the amount is acceptable based on the net limit of the risk, evaluate treaty cessions, and evaluate facultative cessions. In this regard, in the context of reinsurance, the term “cession” is the unit of reinsurance passed to a reinsurer by a primary insurance company which issued a policy to the originally insured. A cession may accordingly be the whole or a portion of single risks, defined policies, or defined division of business, all as agreed in the reinsurance contract. As will be explained in greater detail below, the worksheet includes risk data and one or more reinsurance structures, each of which in turn may include layer data and reinsurance layoff allocation data. The structure may also include details of obligatory treaties and facultative obligatory treaties and facultative reinsurance details. The worksheet can present various alternative views or screens to assist the user in viewing and evaluating the data. For instance, the worksheet may show a strand chart that provides a graphic view of the reinsurance layoff allocation, or a structure summary that summarizes the structure put together by the REM for the risk being processed.

When the user launches the REM 20 from the underwriting system, the REM develops the worksheet for the risk selected by the user. First, the REM captures risk data provided by the underwriting system and, in response to a user selection, displays the data in a risk data screen. This data assists the REM to ultimately define/display the reinsurance layoff allocation. Based on rules, which may include treaty rules, additional coverage rules, and location rules, the REM automatically develops one or more reinsurance structures. A reinsurance structure houses important details regarding the design of the reinsurance risk, layer data, and layoff allocation applicable to specific risk data. Each reinsurance structure includes structure data that support and define the layer and reinsurance layoff allocation within a risk's structure. Examples of data elements that define the reinsurance structure include the division number, profit unit code number, and major class code number. The structure data and risk data form the basis of a treaty filtering process as described in greater detail below.

Within a reinsurance structure, the REM builds a layer table and a layoff allocation table, assigns each reinsurance item to one or more layers, and further requests entry or calculates gross premium for each layer. Also, based on rules, the REM automatically embeds obligatory treaties and cession amounts that are applicable in the corresponding structure, and displays applicable facultative obligatory treaties for the user to decide whether they should be embedded into the worksheet or not. To provide the user an overview of the worksheet or worksheets, a list of the worksheets are provided for viewing on a Risk Summary section.

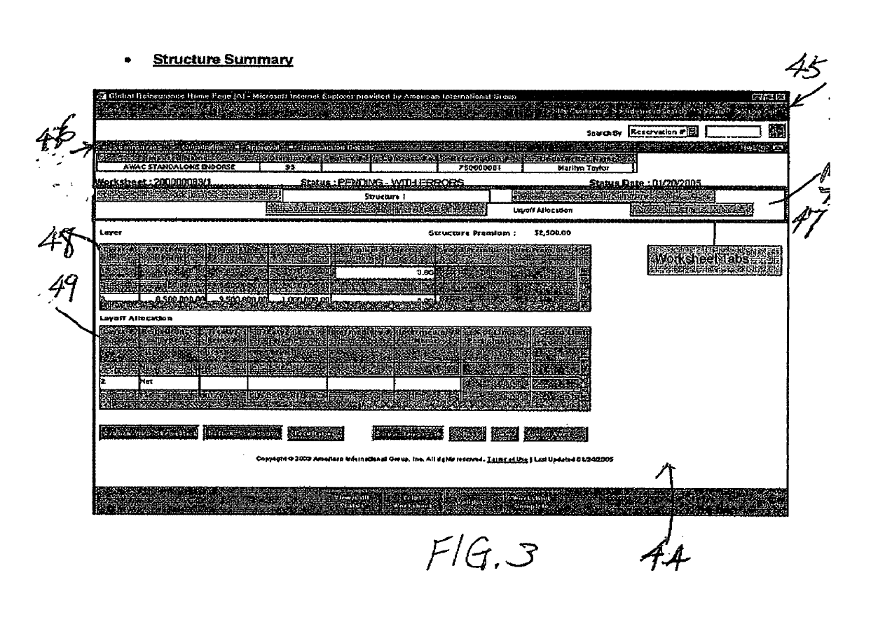

By way of example, FIG. 3 shows an exemplary worksheet 44. In this screen, a general navigation menu bar 45 contains options such as Advanced Search, Help, and Log Out. A menu bar 46 for the risk being processed includes options such as Summaries, Negotiation, Approval, and Transaction Details. Another navigation tool bar 47 contains tabs that can be selected to provide different views of the data of the work sheet, such as Risk Data, Structure Summary, Structure Data, Treaties, Layoff Allocation, and Strand Chart.

In the example shown in FIG. 3, the worksheet 44 presents a “Layoff Allocation” view for a structure named “Structure 1.” In this view, the REM shows in the worksheet a Layer Table 48 that contains a summary of the layers for the risk, and a Layoff Allocation Table 49 that summarizes the layoff allocation for the different layers. In this regard, a “layer” is a category used to group one or more reinsurance layoff allocations based on mutual agreement regarding the attachment point, the layer limit, and the upper limit. An “attachment point” is the monetary amount of a reinsured company's retained risk or loss at which point reinsurance begins to apply. The Layoff Allocation Table 49 includes data regarding the applicable treaties, percentage of limit participation, and ceded limit.

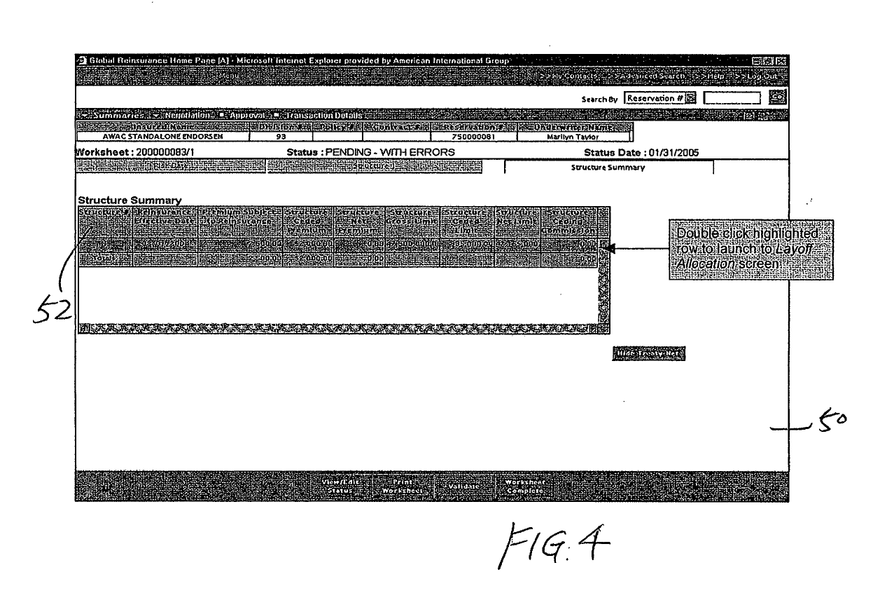

When the user clicks on the Structure Summary tab in the risk-data navigation menu bar 47, the REM presents a Structure Summary screen, an example of such a screen is shown in FIG. 4. The Structure Summary screen contains a Structure Summary table 52 that lists and summarizes the structure or structures constructed for the risk being processed. Generally, the reinsurance structure is a data collection that allows a user to capture information needed to develop and code the details pertinent to a particular reinsurance layoff allocation. A reinsurance structure houses the important details regarding the reinsurance risk's design, layer data, and layoff allocation applicable to specific risk data. A worksheet may use only one reinsurance structure, but additional structures may be required when, for example, the risk data is changed or if different reinsurance layoff allocations apply to the same attachment point within the risk within the REM. Within a worksheet, the use of structures allows a risk being evaluated to be broken down into subsets, and each structure supports a subset of the risk's reinsurance allocation.

A reinsurance structure of a worksheet is automatically developed by the REM 20 initially. To that end, the REM 20 retrieves structure data from the database 32 of the underwriting system, defines one or more structures based on rules, and displays the constructed reinsurance structure or structures. Based also on those rules, the REM develops the Reinsurance Layoff Allocation (“RLA”) screen, as illustrated in FIG. 3. This involves assigning and calculating layers. Each layer identified in the Layer table 48 has data fields including Attachment Point, Upper Limit, Limit, Premium Subject to Reinsurance, Ceded Premium, and Net Premium. In the Layoff Allocation Table 49, the REM displays a row for each reinsurance type of each layer. The possible reinsurance types include, for example, facultative, obligatory treaty, and facultative obligatory treaty.

For facultative reinsurance, the Ceded Premium/Net Premium amounts in the Layoff Allocation Table may need to be changed by the user. This occurs when the user receives a facultative quote that applies to multiple structures, or when the user applies disproportional facultative reinsurance. Also, due to treaty reinsurance, the Ceded Premium may need to be entered because no cession rates may be available in the database of the treaty rules system for the REM to automatically populate this data field.

In accordance with a feature of the invention, the REM incorporates applicable treaties in the worksheet for evaluating a risk. A treaty is a form of reinsurance in which the terms and conditions generally apply to a book of business that meets specific predetermined criteria. Many treaties are written as annual policies, but the duration of the coverage can vary. Treaties may be either obligatory or facultative obligatory, based on the requirements of the reinsurance officers negotiating them. Generally, an “obligatory treaty” is a contract under which the subject matter risks must be ceded by the ceding company in accordance with contract terms and must be accepted by the reinsurer company. In contrast, a “facultative obligatory” treaty defines terms and availability that are predetermined for an entire class of risks, but the ceding of an individual and eligible account is not necessarily automatic, depending on the definitions of what can be ceded. As defined in the agreement, either the ceding company is “obligated” to cede the risk to the reinsurer while the reinsurer is given the ability, or “faculty,” to accept or reject the risk, or the reinsurer is obligated to accept the risk while the ceding company is given the faculty to cede or not.

Treaties are typically set up for specific lines of business (e.g., property, auto, general liability) to help and insurer manage its total exposure to losses on a company-wide basis. When an insurance company decides to limit its net retention across a defined spectrum of risk, a treaty becomes a much more efficient means for bringing reinsurance into the underwriting process. Instead of having to make a facultative (e.g., negotiable”) placement on each account, the insurance company identifies all accounts that meet treaty requirements and codes the cessions appropriately. In this way, treaties greatly assist underwriters in meeting workflow deadlines by providing reinsurance availability for pre-defined circumstances. When there are many treaties that exist within the reinsurance provider, however, manually keeping track of all the treaties and applying the treaties can introduce human errors. For instance, the underwriter may not understand the nuances of the treaty rules and may make wrong decisions.

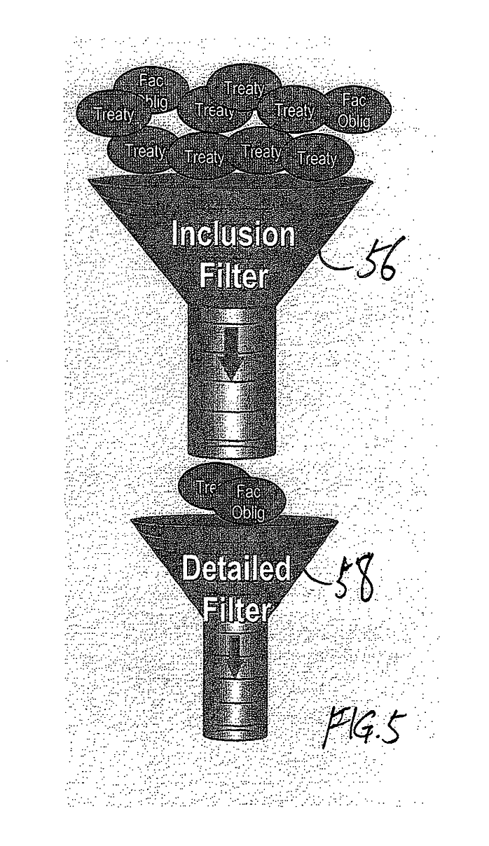

The method and system of the invention allow treaties to be effectively incorporated into the computer-assisted risk evaluation process to greatly simplify the application of treaty-based rules in the calculations for the layoff allocation for the risk. In a preferred embodiment, a filtering process is used to identify all treaties that may apply to a specific risk. As illustrated in FIG. 5, the filtering process involves two levels. At the first level, an inclusion filter 56 is used for all treaties in all profit centers to identify treaties that might apply to a risk, based on high-level criteria such as, for example, the division number, section number, and profit unit code, major class code, and treaty effective/expiration date. Treaties that have passed the inclusion filter 56 on level one are then evaluated by a detailed filter 58 on level 2. The rules used by the detailed filter 58 for selecting treaties may be specific to each treaty, and those rules may be determined by the respective profit centers. For example, there may be a rule associated with a treaty stating that the treaty does not apply to any risk with a revenue that exceeds “x” amount. In such as case, the treaty is not applicable to a risk that has a revenue exceeding “x”, and will not be selected by the detailed filter 58 for that risk. To enable the REM to perform the level-two filtering function, the data required to execute the rules are provided to the REM. The REM performs the filtering, and generates a filtered treaty list that contains the treaties that have passed the level-two filtering.

After the potentially applicable treaties are located through the filtering process, the REM incorporates the treaties in the worksheet for the risk being evaluated. If a treaty is captured by the underwriting system as an obligatory treaty, the REM automatically embeds that treaty within the reinsurance structure of the worksheet within the applicable layer. The obligatory treaty will be displayed in a Treaties screen with a checkmark in the Select column.

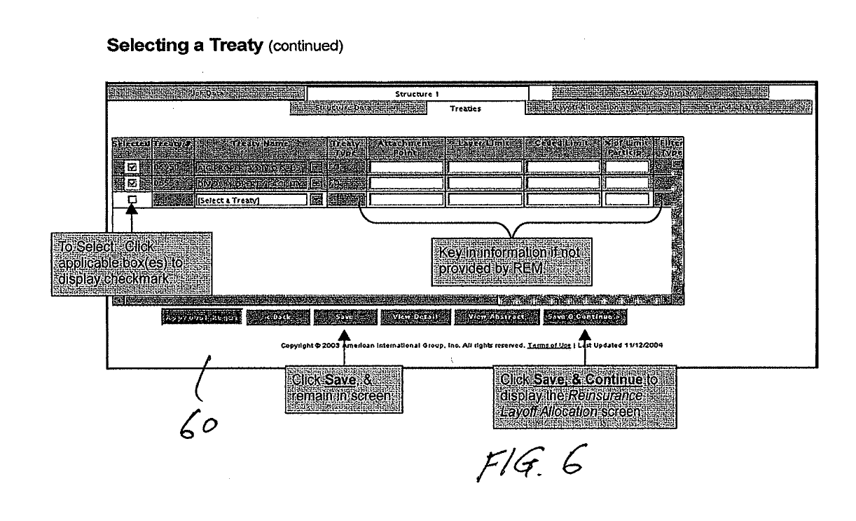

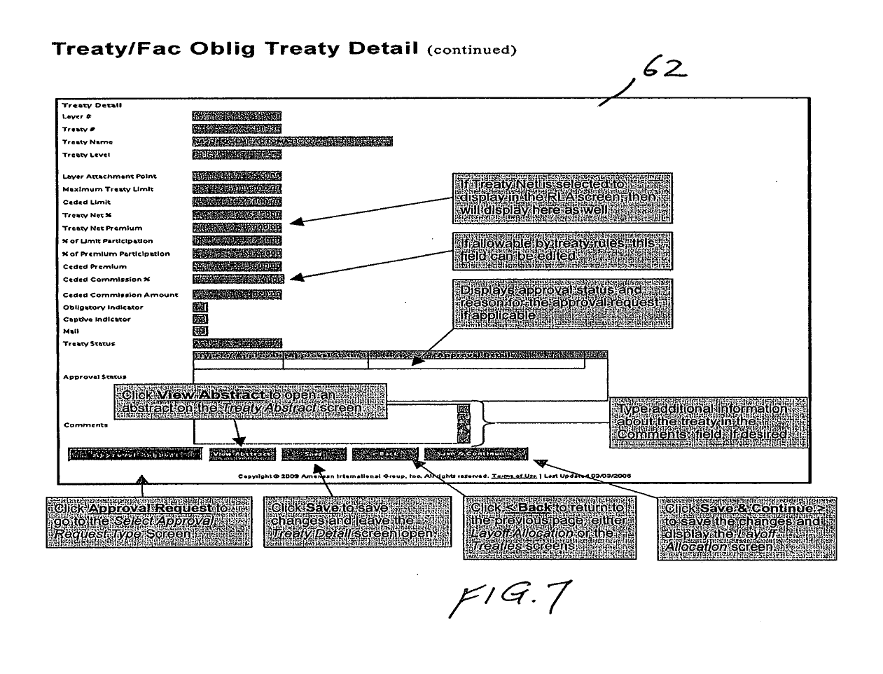

If, on the other hand, a treaty is captured in the underwriting system as a facultative obligatory treaty, the REM will first display that treaty in the Treaties screen without a checkmark in the Select column. FIG. 6 shows an exemplary Treaties screen 60, in which the two listed treaties are both of the facultative obligatory (“FO”) type. The Treaties screen allows the user to manually select a facultative obligatory treaty by checking the box in the Select column for that treaty. If the user selects the treaty, the reinsurance structure within the worksheet will include that treaty within the applicable layer. If, however, the user does not select the treaty, then the layer for this coverage will be either captured as Net Premium or ceded to facultative reinsurer, if negotiated and embedded by the user in the structure of the worksheet. The details of the treaty can be viewed in a Treaty Details screen displayed by the REM. An example of a Treaty Details screen 62 is shown in FIG. 7.

Based on treaty rules, the REM calculates treaty cession amounts if available. REM further displays treaty ceding commission percentage, and calculates and displays ceding commission amount. Here, the ceding commission is the amount of the reinsurance premium paid to the agent, broker, or intermediary by the reinsurer for part or all of a ceding company's acquisition and other costs associated with writing the business. The REM may also display or hide treaty net (“take-back”) premium/limits, based on division rules.

The values for the Attachment Point, Layer Limit, and Ceded Limit are either automatically displayed based on the treaty rules in the treaty rules system, or not displayed if the treaty has been set up to allow the user to change the variable attachment point and/or variable ceded limit. In the latter case, the data has to be manually entered in all treaties that have been selected. After the treaty filtering process is complete, the REM accesses the treaty rules in the underwriting system and determines if cession rates are available. If the cession rates are available, the REM applies the treaty's cession rates stored in the treaty system to the structure's “Premium Subject To Reinsurance” amount. The REM then displays that calculation in the Ceded Premium field in the Treaty Detail screen and the Reinsurance Layoff Allocation screen. The Ceded Limit field defines the limit for which the reinsurer is liable to pay in the event of covered losses. The Ceded Premium field contains the amount paid by the ceding company to the reinsurer in consideration for the liability assumed by the reinsurer, inclusive of ceding commission. If the cession rates are not available, no data is displayed in the Ceded Premium field in the Treaty Detail screen and the Reinsurance Layoff Allocation screen. In that case, the user will be required to calculate the amount manually and enter it into the REM. Based on source rules, the REM determines whether to display the treaty net premium and treaty net limits or to include treaty net premium in the treaty ceded premium and to include treaty net limits in the treaty ceded limits.

The REM further determines if any variable treaty can be attached more than once in the structure. If not, then the REM will not display that treaty in the Select a Treaty drop down menu in the Treaties screen. If yes, the REM will display the treaty in the Select a Treaty drop down menu in the Treaties screen. The REM also determines if any treaty's Ceding Commission % value can be edited by the user. If no, the user will not be allowed to modify that value. If so, the user is allowed to modify the Ceding Commission % value in the Treaty Details screen.

Besides treaties, the evaluation of a risk may also involve “facultative quotes.” In accordance with another feature of the invention, the computer-assisted processing also facilitates facultative reinsurance. Facultative reinsurance is the reinsurance of part or all of one or more policies that are negotiated and taken to conclusion, meaning taken to bind. The word “facultative” connotes that both the primary insurer and the reinsurer have the option of accepting or rejecting the individual submission. REM can store quotes and binders, endorsements, cancellations, and reinstatements.

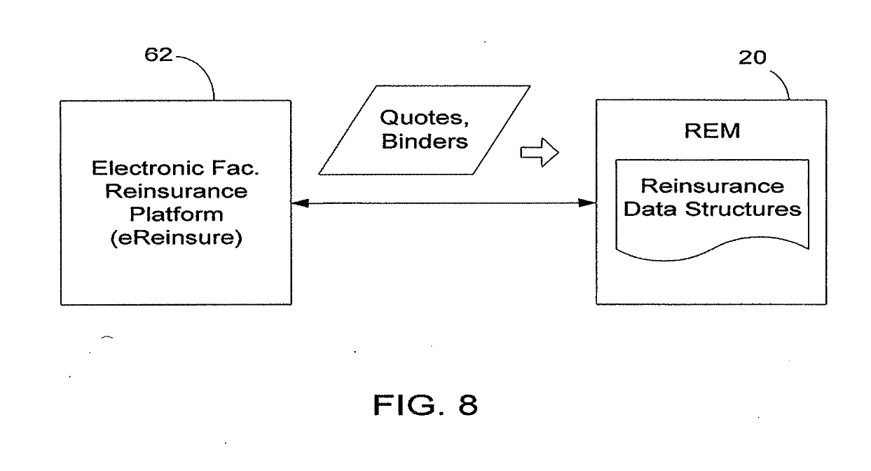

Referring to FIG. 8, in accordance with a feature of a preferred embodiment, the REM is integrated with an electronic platform 62 for facultative reinsurance negotiations over computer networks. In one implementation, the electronic platform 62 is an on-line platform called “eReinsurance®.” The quotes and binders negotiated with the reinsurer/intermediary via the eReinsurance platform are systematically routed to the REM, which automatically uses the received quotes and binders to populate the list in the Quote List screen and to display the data for viewing by the user. This feature has multiple advantages. First, the automated data transfer from the eReinsurance platform to the REM avoids potential mistakes that may be made if the data were to be manually keyed in. Second, as described in greater detail below, the REM can ensure that all facultative quotes are properly bound by requiring binders for the quotes before the worksheet can be finalized. Third, the storage of information regarding the certificates in a database accessible by the REM to allow viewing of the certificates for the bound quotes negotiated via the eReinsurance platform 62 provides proper documentation of the bound quotes to prevent future dispute.

In one embodiment, a user may launch the eReinsurance platform from the REM, and send submission data to the eReinsurance platform. This feature of allowing data to be transferred from the REM to the eReinsurance platform obviates the need to re-enter data that is required if the eReinsurance platform has to be separately launched.

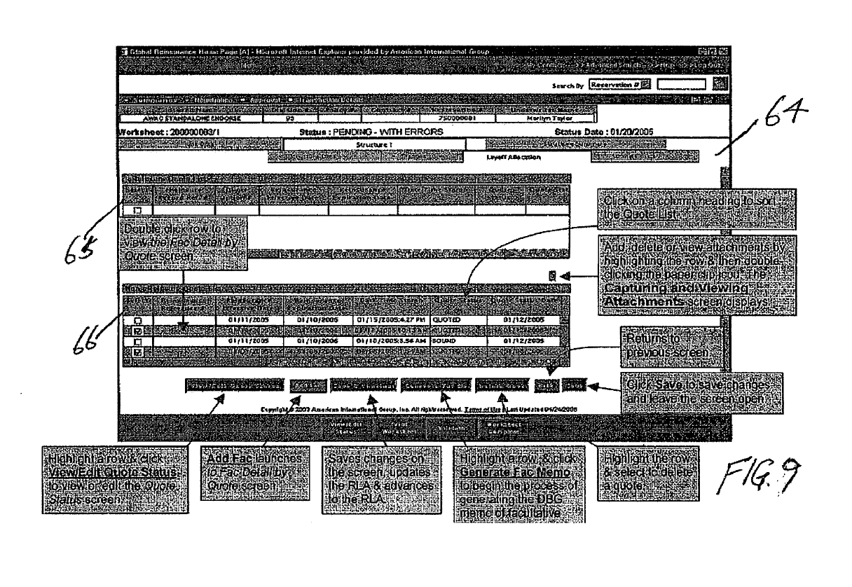

To view the facultative agreements embedded in the worksheet, the user can click on the “Facultative” button in the Reinsurance Layoff Allocation screen as illustrated in FIG. 3. In response, the REM presents a Quote List screen. FIG. 9 shows an exemplary Quote List screen 64. An eReinsurance Quote List table 65 lists those quotes or binders that have been negotiated via the eReinsurance platform. A Non-eReinsurance Quote List table 66 shows quotes or binders that were entered into the system manually through a Fac Detail by Quote screen. The Quote List screen preferably displays a complete list of all quotes and binders for the risk, including all earlier and current versions of the quotes. Thus, the user should review the date/time stamp for each quote to determine whether it is the most current version. Only the most current version can be finalized in the reinsurance layoff allocation. The Quote List screen also displays a complete list of post-bind transactions applicable to the facultative reinsurance binder.

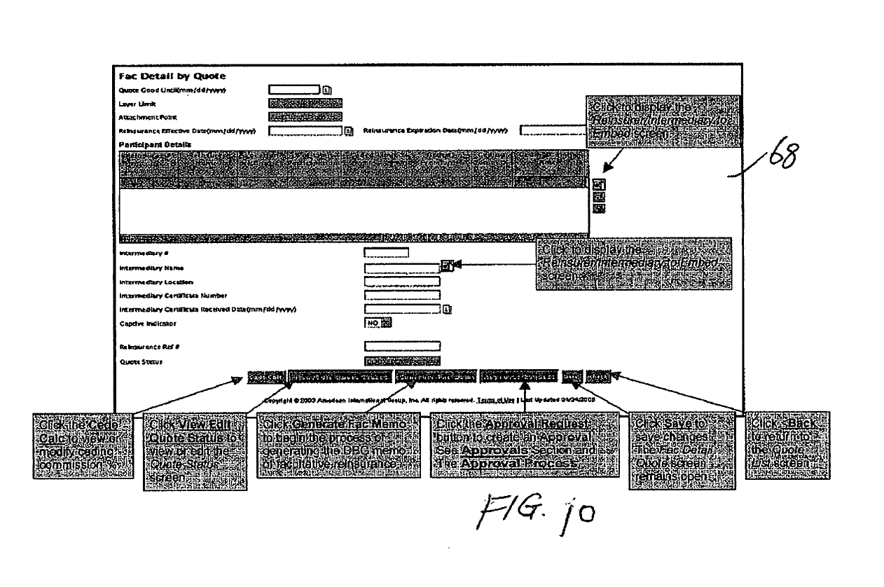

The Quote List screen allows the user to select or deselect facultative quotes, and to manually add, modify, or delete them. When the user selects a facultative quote by clicking the Select box for that quote, and clicks the Save button, the REM automatically embeds a layer in the structure, if required, and adds a row for the facultative quote in the structure to display information including the applicable ceded premium, ceded limit, % of limit participation, % of premium participation, reinsurer, intermediary, ceding commission %, and ceding commission amount. The user may also manually add a non- eReinsurance quote by clicking the Add Fac button in the Quote List screen. In response, the REM presents a Fac Detail by Quote screen to allow the user to enter data for the quote. An example of a Fac Detail by Quote screen 68 is shown in FIG. 10. This screen displays the details of the facultative quote. To modify an existing non-eReinsurance quote, the user clicks the quote in the Quote List screen, and the REM displays the Fac Detail by Quote screen for the user to modify the data for that quote.

The integration of the REM and the eReinsurance platform further facilitates the synchronization of data concerning post-bind changes. Examples of post-bind changes include cancellation of facultative reinsurance, changing the terms and conditions of the facultative reinsurance, increasing the limits of facultative reinsurance, reinstating a cancelled facultative reinsurance item, etc. In accordance with a feature of the embodiment, for a given post-bind change concerning facultative reinsurance initially negotiated through the eReinsurance platform, the user may go back to the eReinsurance platform to require a notice from the reinsurer to confirm the post-bind change. For instance, for a post-bind change that cancels the facultative reinsurance, the user may request a cancellation notice through the eReinsurance platform. For a post-bind change that alters the reinsurance terms or conditions, the user may request an endorsement from the reinsurer via the eReinsurance platform. Once the change is agreed upon by the reinsurer, the REM will display the cancellation or endorsement in the Quote List screen. One important function served by requiring a confirmation from the reinsurer via the eReinsurance platform before allowing post-bind changes in the REM is that the data in the eReinsurance platform will be in sync with the data in the REM.

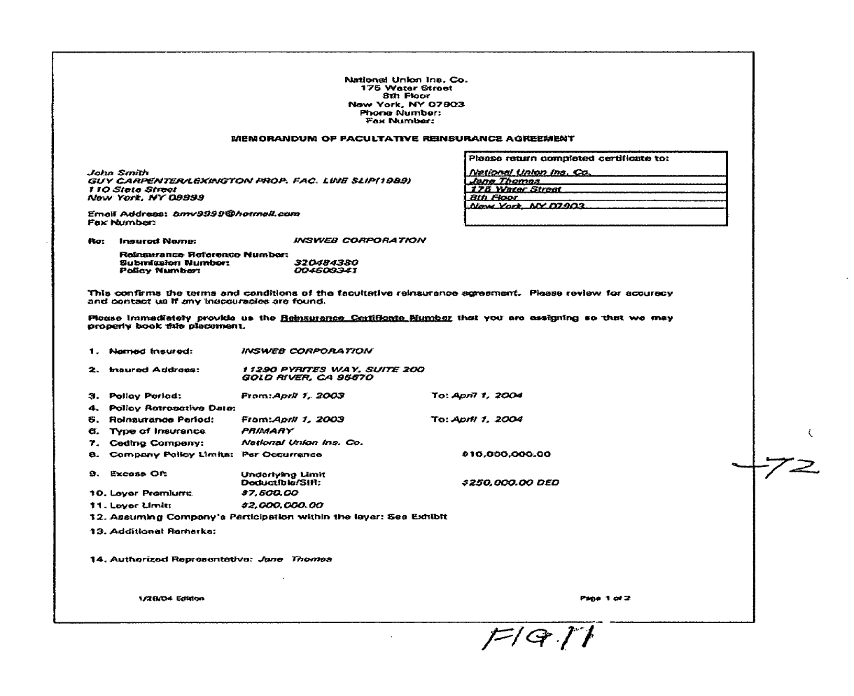

In accordance with a feature of the embodiment, to ensure the proper documentation of the binding of quotes for facultative reinsurance not negotiated using the eReinsurance platform or the like, the REM provides the function of generating a Memorandum of Facultative Reinsurance that is to be routed to the reinsurer or intermediary for the quotes that are to be bound. The Memorandum is intended to confirm the facultative coverage, terms, and conditions to prevent disputes with reinsurers in the event of loss. In one implementation, the generation of the memorandum is required in order to change the quote status to “Bound,” and the worksheet will not finalize until the memorandum has been routed. To generate the Memorandum, the user highlights the quote in the Non-eReinsurance Quote List table and clicks the Generate Fac Memo button, and enters the names and addresses into the form presented by the REM for the memorandum delivery. The user also enters a “Send Certificate to” address, which is the address to which the user wants the reinsurer/intermediary to mail a certificate regarding the facultative reinsurance. In this regard, a certificate serves as evidence of coverage and usually contains explicit terms and conditions governing how the reinsurer will respond in the event of loss. The user can preview the Memorandum before it is sent out. An example of a Memorandum of Facultative Reinsurance 72 is shown in FIG. 11. If the data in the Memorandum are accurate, the user clicks a Route button, and the REM automatically transmits (e.g., via e-mail) the Memorandum to the reinsurer/intermediary.

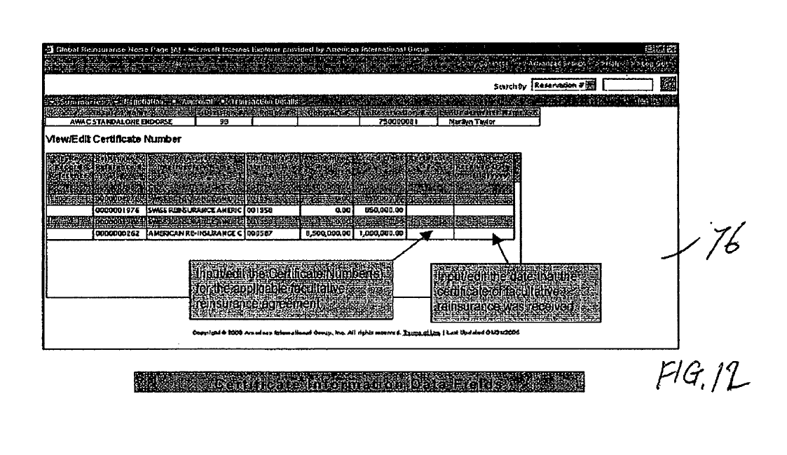

Once a worksheet is finalized, the REM provides a View/Edit Certificate screen that displays a list of the risk's bound facultative reinsurance, as captured in the Fac Detail by Quote screen. An exemplary View/Edit Certificate screen 76 is shown in FIG. 12. This screen allows the user to input or edit the Certificate Number and Certificate Scanned Date for each facultative reinsurance negotiation.

One step in processing a worksheet for a risk is obtaining approvals, if necessary. A request for approval is needed if the status in an applicable screen in REM displays “Needs Approval,” or if the underwriting guidelines dictate that approval is required. Generally, there are three types of approval requests. The first type is the “treaty/facultative obligatory approval request.” An approval of this type is required either to delete an obligatory treaty for the risk or because the treaty has a special exception. The second type is the “security request.” Either the facultative reinsurer is not authorized by the insurance company, or the facultative reinsurer has exceeded its approval limits. The third type is the “authority to negotiate request.” The underwriter may be required to get approval for authority to quote/bind facultative reinsurance for a risk. When approvals are required, the REM captures the approvals on a risk level. Once an approval response is received, the REM automatically captures that response in the applicable structure in the worksheet for that risk.

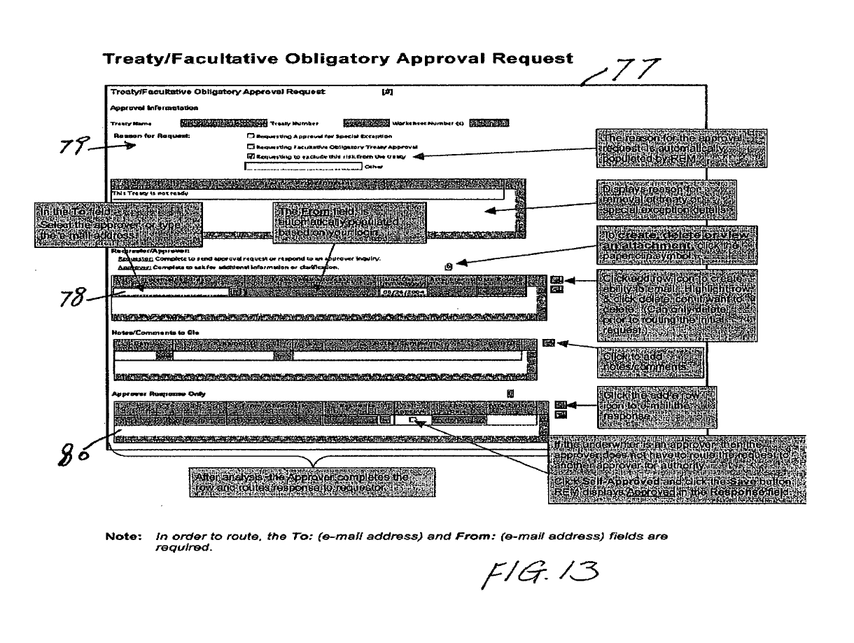

To facilitate the approval process, the REM generates approval request forms for the user based on the type of need for approval. In one implementation, the REM provides three approval request screens for the generation of a treaty/facultative obligatory authority request, a security authority request, and a facultative request, respectively. For instance, in the Treaty Details screen as shown in FIG. 7, or in the Treaties screen as shown in FIG. 6, the user can click the Approval Request button to create, view, and edit an approval request concern the treaty. Similarly, the user can click the Approval Request button in the Fac Details by Quote screen as shown in FIG. 10 to create, view and edit a request for security approval or facultative authority for a quote. In response, the REM presents an interface screen to allow the user to enter or modify information required for the approval request. When the user selects the Send button on any of the approval request screens, the REM generates an approval request form and automatically sends (e.g., via e-mail) the request to the address captured in the “To” field in the approval request screen. By way of example, FIG. 13 shows a user interface screen 77 for assisting a user in generating a treaty/facultative obligatory approval request. The interface screen 77 contains fields for the user to enter information required for the request. In the “To” field 78, the user may select the approver from a list, or enter the e-mail address. The reason for the approval request may be automatically populated by the REM by selecting one of the Reason for Request options 79, or proved by the user. The interface screen further includes an Approval Response Only table 80, the fields of which are to be filled by the approver. The interface screen 77 may also contain other fields for the user to view and edit additional risk information.

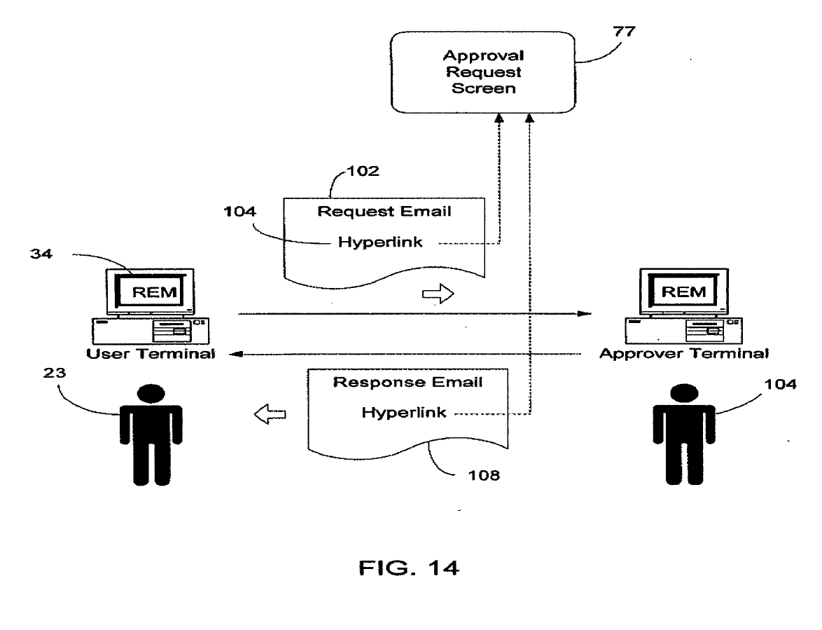

Referring to FIG. 14, after entering the relevant data into the approval request screen, the user 23 can click the “Send” button in the menu bar at the bottom of the screen. In response, REM 20 creates an e-mail 102 and forwards it to the e-mail address captured in the “To” field of the approval request screen. This e-mail 102 is delivered to the approver 104 using a suitable e-mail exchange program and via a network, which may be for example an intranet or the Internet. In one implementation as shown in FIG. 14, the e-mail 104 includes a hyperlink 106. When the approver 104 clicks on the hyperlink 106 in the received e-mail, the computer of the approver automatically takes the approver to the logon screen of the REM. Once the approver has successfully completed the logon, he is taken directly to the applicable approval request screen, such as the one shown in FIG. 13. Alternatively, if the approver is already in the REM, he can assess the risk by using the search function provided by the REM, select “Approvals” in the risk menu bar, and then select the applicable approval request. The approver can then enter data into the Approval Response Only table in the approval request screen 77. The approver can also use the approval request screen to send a note to the requester asking for more information. The approver can then click an icon in the approval request screen to cause the REM to send an e-mail response 108 back to the requestor 23. In this way, the same set of data used to populate the approval request screen 77 is used by the requestor and approver to exchange information for obtaining the approval, and fields in the screen are updated through the approval process.

One significant feature of the computer-assisted reinsurance processing of the invention is the validation function. In a preferred embodiment, when the user begins the finalization process of a risk, the REM performs validation operations automatically to assist the user to complete the worksheet correctly. Various edits are performed, and the data are validated against predetermined rules. To that end, rules are built into the REM such that it will not allow the worksheet to be given the finalized status until any applicable errors, if found, are corrected.

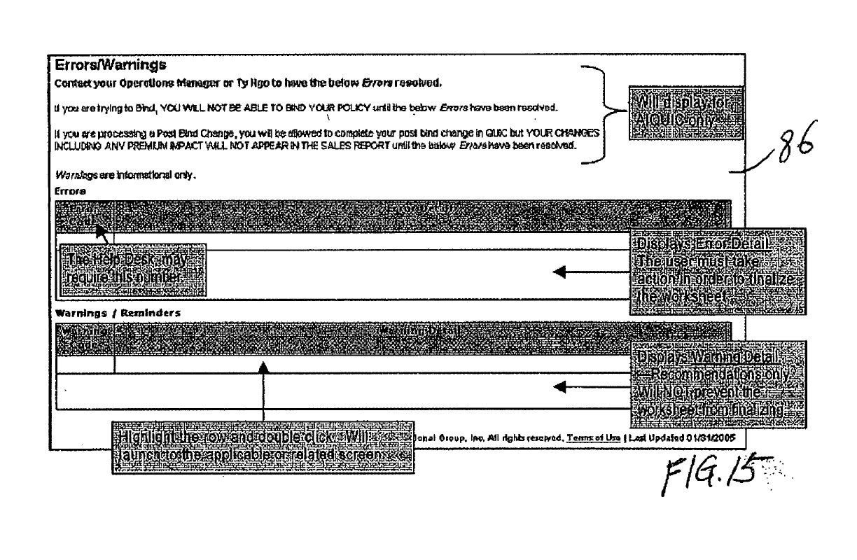

There are many different issues that may exist in the worksheet for the risk and prevent the worksheet from being finalized. For example, the worksheet cannot be finalized if a special exception approval is required for a treaty, if an obligatory treaty has been deleted from the deleted from the structure without approval, if facultative reinsurance is added to the structure with a non-approved reinsurer, if the facultative reinsurer's ceded limit exceeds the company approved amount for the risk, or if the Memorandum of Facultative Reinsurance has not been routed, which indicates that the quote is not bound. There are many other possible issues that can be identified by the REM to determine that the worksheet is not in condition to be made final. As a result of the validation process, the REM identifies errors and warnings that apply to the risk, and display error messages and warning messages in Errors/Warnings screens for viewing by the user. An example of the Error/Warning screen is shown in FIG. 15. In the Error/Warning screen 86, the REM displays both error and warning messages. An error message notifies the user the reason why the worksheet is not complete and cannot be finalized. A warning message, on the other hand, provides a user a reminder that an action may have to be taken in order to complete the process of finalizing the reinsure, but does not prevent the worksheet being finalized.

The validation of the worksheet data may be launched automatically by the REM. This may occur, for instance, when the user launches REM from a binding process in the underwriting system, the data are transferred to the REM for populating the worksheet. The REM will then automatically validate the data. Alternatively, the validation may be performed upon request by the user. For instance, the user can access the Errors/Warning screen by selecting the Validation button in the menu in the worksheet as shown in FIG. 3.

If the REM has not found any error in the validation process, it displays the worksheet to the user with a worksheet status of “Pending-No Errors.” This provides the user the ability to analyze the gross/cede/net premium amounts of the risk. At this point, the user can still modify the worksheet, if needed. If no further editing of the worksheet is needed, the user can launch the worksheet back to the underwriting system.

If, however, the REM has found errors in the validation for a new or renewal process, the REM displays an Errors/Warning Screen to the user. Since REM has found errors, the worksheet status is set to “Pending with Errors.” Once all the errors identified by the REM have been corrected, the user can click the “Validate” button again. In response, the REM will re-validate the worksheet. If no error is found, the REM changes the worksheet status to “Pending-No Errors.” The user can then launch back to the underwriting system. The worksheet status will automatically change to “Final” once the underwriting system completes the bind process and the forward the risk to the corporate record system for booking. The underwriting system also automatically forwards the policy number to the REM. Validation may also be applied in a post-bind process.

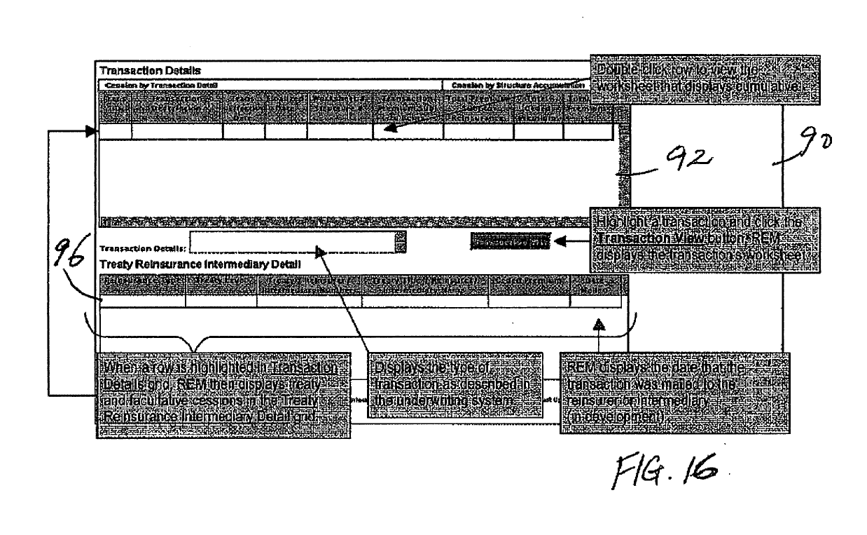

After the worksheet for a transaction has been finalized, the REM allows viewing of the details of that transaction. To view the transaction details, the user clicks the Transaction Details button in the Toolbar Navigation menu of the REM upper navigation bar. In response, the REM displays a Transaction Details screen 90 that shows a Transaction Details table 92 containing data regarding the transaction, as illustrated in FIG. 16. Using that table, the user has the ability to access the transaction's worksheet and get a cumulative view of the worksheet. In addition, the screen shows a Treaty-Reinsurer-Intermediary Detail table 96 that displays the treaty, reinsurer, and intermediary details for the transaction.

After a transaction has been bound by the underwriting system, the REM can be used to perform post-bind operations on the transaction. The post-bind operations include, for instance, risk data change, cession rules/calculations, cumulative transaction worksheet display, validation, error/warning display, and finalizing the transaction.

In accordance with an aspect of the invention, the REM also facilitates reporting for reviewing and status-check purposes by giving the user the option to generate various pre-formatted reports. In one embodiment, there are at multiple types of reports that may be generated at various stages of the reinsurance transaction process regarding: policies not ceded to treaty, approved request by status, facultative negotiations, bound policies with manual overridden cession calculations, bound policies via REM, policy detail by treaty, policy detail on internal reinsurers, list of policies by insured, policies with facultative coverage, second level treaty special exceptions, binder/certificate past due, reinsurer/intermediary mailing report, 100% net, pending negotiations, certificate number not captured in REM. Other types of reports may also be generated.

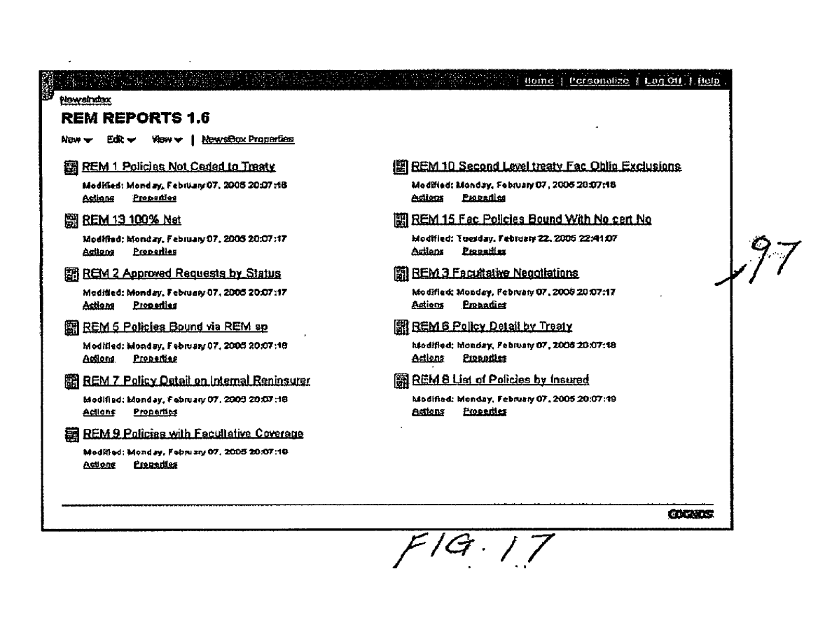

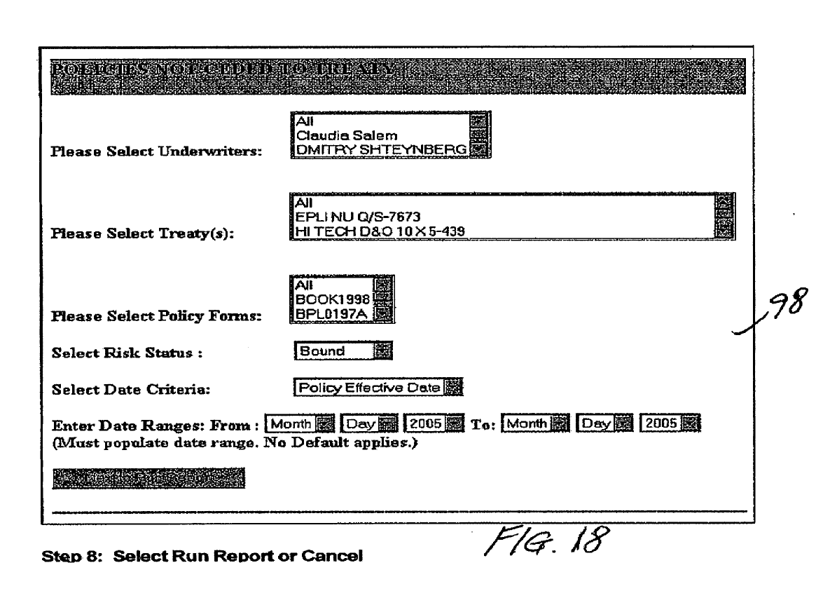

As shown in FIG. 17, to facilitate the generation of reports, the REM provides a REM Reports screen 97 that lists the types of reports available. After the user selects the type of report to be generated, the REM provides user interface screens to allow the user to enter certain general information, such as the credited or working region, branch, and division, and to select filters and specify ranges for the data to be included in the report. By way of example, FIG. 18 shows an interface screen 98 for the user to select filters and a date range for generating a “Policies Not Ceded to Treaty” report. The REM then applies the filters and date range to the data stored in the database 32 (FIG. 1) to generate the report. The report can then be displayed or printed for viewing, stored in the database, or transmitted electronically to selected recipients.

In view of the many possible embodiments to which the principles of this invention may be applied, it should be recognized that the embodiment described herein with respect to the drawing figures is meant to be illustrative only and should not be taken as limiting the scope of invention. For example, those of skill in the art will recognize that the elements of the illustrated embodiment shown in software may be implemented in hardware and vice versa or that the illustrated embodiment can be modified in arrangement and detail without departing from the spirit of the invention. Therefore, the invention as described herein contemplates all such embodiments as may come within the scope of the following claims and equivalents thereof.

1. A method of performing reinsurance transaction processing for a risk, comprising:
identifying a list of treaties applicable to the risk;
presenting, by a computer programming module, the list of treaties in a worksheet to a user for selecting treaties to be applied to the risk; and
applying, by the computer module, the selected treaties for determining reinsurance transaction parameters for the risk.

2. A method as in claim 1, wherein the treaties include at least one facultative obligatory treaty.

3. A method as in claim 1, wherein the treaties include at least one obligatory treaty.

4. A method as in claim 1, wherein the step of identifying includes applying at least a filter to a pool of available treaties to identify the list of treaties applicable to the risk.

5. A method as in claim 1, further including the step of generating by the computer programming module a layoff allocation table for the risk based on the selected treaties.

6. A method as in claim 1, further including the steps of:
displaying by the computer programming module a list of negotiated facultative reinsurance items in the worksheet for receiving user input to select negotiated facultative reinsurance items to be applied to the risk;
applying the selected negotiated facultative reinsurance items to determine reinsurance transaction parameters for the risk.

7. A method as in claim 6, further including the steps of:
generating by the computer programming module a memorandum for confirming one of the selected negotiated facultative reinsurance items applied to the risk, and transmitting the memorandum to a specified recipient.

8. A method as in claim 1, further including the steps of:
identifying, by the computer programming module, an approval required for processing the reinsurance transaction for the risk; and
generating, by the computer programming module, an approval request for the identified approval.

9. A method as in claim 8, further including the step of transmitting by the computer programming module the approval request to a selected recipient.

10. A method as in claim 8, wherein the approval is for deleting an obligatory treaty or addressing an exception in a treaty.

11. A method as in claim 8, wherein the approval is for obtaining authority to negotiate facultative reinsurance.

12. A method as in claim 8, wherein the approval is for approving a reinsurer not on an approved list or for approving a reinsurer that has exceeded its allowed limit.

13. A method as in claim 1, further including the steps of:
validating, by the computer programming module, data in the worksheet for the risk to identify errors; and
presenting, by the computer programming module, error messages and/or warnings regarding the identified errors.

14. A method as in claim 13, where the step of validating includes determining whether a facultative quote negotiated through an electronic platform has been bound.

15. A system for processing reinsurance transactions, comprising:
a database containing data representing risks, treaties and facultative reinsurance;
a reinsurance module for providing computer-assisted reinsurance transaction processing, the reinsurance module being programmed to perform steps of identifying a list of treaties applicable to a risk, presenting the list of treaties in a worksheet to a user for selecting treaties to be applied to the risk, and applying the selected treaties to determine reinsurance transaction parameters for the risk.

16. A system as in claim 15, wherein the treaties include at least one facultative obligatory treaty.

17. A system as in claim 15, wherein the treaties include at least one obligatory treaty.

18. A system as in claim 15, wherein the reinsurance module is programmed to apply at least one filter to a pool of available treaties to identify the list of treaties applicable to the risk.

19. A system as in claim 15, wherein the reinsurance module is programmed to generate layoff allocation data for the risk.

20. A system as in claim 15, wherein the reinsurance module is further programmed to display a list of negotiated facultative reinsurance items in the worksheet for receiving user input to select negotiated facultative reinsurance items to be applied to the risk, and to apply the selected negotiated facultative reinsurance items to determine reinsurance transaction parameters for the risk.

21. A system as in claim 15, wherein the reinsurance module is further programmed to generate a memorandum for confirming one of the selected negotiated facultative reinsurance items applied to the risk.

22. A system as in claim 15, wherein the reinsurance module is further programmed to identify an approval required for processing the reinsurance transaction for the risk, and to generate an approval request for the identified approval.

23. A system as in claim 15, wherein the reinsurance module is further programmed to validate data in the worksheet for the risk to identify errors and display error messages and/or warnings regarding the identified errors.

24. A system as in claim 15, wherein the reinsurance module resides on a local area network.

25. A system as in claim 15, wherein the reinsurance module is accessible via a browser.

26. A method of performing reinsurance transaction processing for a risk by a computer programming module, comprising:
receiving data for a risk to be processed for reinsurance;
generating at least one reinsurance structure in a worksheet for processing said risk, said reinsurance structure including reinsurance layoff allocation data; and
presenting the worksheet containing the reinsurance structure in a user interface screen for viewing and editing by a user.

27. A method as in claim 26, wherein the reinsurance structure further includes data regarding a treaty applicable to the risk.

28. A method as in claim 27, wherein the treaty is a facultative obligatory treaty.

29. A method as in claim 27, wherein the treaty is an obligatory treaty.

30. A method as in claim 26, wherein the reinsurance structure includes data regarding a negotiated facultative reinsurance item.

31. A method as in claim 26, wherein the step of generating generates multiple reinsurance structures based on treaty rules for processing the risk.

32. A method of performing reinsurance transaction processing for a risk by a computer programming module, comprising:
receiving facultative reinsurance data applicable to a risk being processed for reinsurance from an electronic platform for negotiating facultative reinsurance, said facultative reinsurance data being negotiated through the electronic platform;
generating at least one reinsurance structure for processing said risk; and
populating, by the computer programming module, the reinsurance structure using the received facultative reinsurance data.

33. A method as in claim 32, wherein the facultative reinsurance data includes bound quotes applicable to the risk being processed.

34. A method as in claim 33, including the step of verifying that a facultative quote has been bound.

35. A method as in claim 34, including accessing a view of a stored certificate for the facultative quote.

36. A method of performing reinsurance transaction processing for a risk by a computer programming module, comprising:
identifying that an approval is required for the reinsurance transaction processing;
presenting a user interface screen having fields for entering information for generating an approval request;
generating an approval request based on information entered through the user interface screen;
transmitting electronically the approval request to a selected recipient; and
receiving electronically an approval responsive to the approval request.

37. A method as in claim 36, wherein the steps of transmitting and receiving are performed via e-mail.

38. A method as in claim 37, wherein the step of transmitting includes sending an e-mail message containing a link to the user interface screen.

39. A method as in claim 36, including updating data in a reinsurance structure for processing the risk to indicate receipt of the approval.

40. A method as in claim 39, including storing the approval in a database.

41. A method of performing reinsurance transaction processing for a risk, comprising:
providing a database containing data pertaining to reinsurance transaction processing for a risk;
presenting a first user interface screen listing types of reports available for selecting a report to be generated;
presenting a second user interface screen for selecting filters for generating the report; and
applying the selected filters to the data in the database to generate the selected report.

42. A method as in claim 41, including the step of displaying the selected report for viewing.
